(19) United States
(12) Patent Application Publication
(10) Pub. No.: US 2024/0292430 A1
(43) Pub. Date: Aug. 29, 2024

(54) INFORMATION TRANSMISSION METHOD AND APPARATUS, TERMINAL, NETWORK SIDE DEVICE, AND READABLE STORAGE MEDIUM

(71) Applicant: VIVO MOBILE COMMUNICATION CO., LTD., Guangdong (CN)

(72) Inventors: Yi GU, Guangdong (CN); Kai WU, Guangdong (CN)

(21) Appl. No.: 18/655,771

(22) Filed: May 6, 2024

Related U.S. Application Data
(63) Continuation of application No. PCT/CN2022/131869, filed on Nov. 15, 2022.

(30) Foreign Application Priority Data
Nov. 17, 2021 (CN) 202111364824.3

(51) Int. Cl. H04W 72/232; H04L 27/26

(52) U.S. Cl. CPC H04W 72/232; H04L 27/2605

(57) ABSTRACT

This application discloses an information transmission method and apparatus, a terminal, a network side device, and a readable storage medium. The information transmission method in embodiments of this application includes: receiving, by a terminal, first signaling sent by a network side device, where the first signaling includes at least one of the following: first indication information, indicating the terminal to switch a transmission waveform; and waveform information, used for determining information about a target transmission waveform.

### CROSS-REFERENCE TO RELATED APPLICATIONS

This application is a Bypass continuation application of PCT International Application No. PCT/CN2022/131869 filed on Nov. 15, 2022, which claims priority to Chinese Patent Application No. 202111364824.3, entitled “INFORMATION TRANSMISSION METHOD AND APPARATUS, TERMINAL, NETWORK SIDE DEVICE, AND READABLE STORAGE MEDIUM” and filed on Nov. 17, 2021, which are incorporated herein by reference in their entireties.

### TECHNICAL FIELD

This application relates to the field of communication technologies, and specifically, to an information transmission method and apparatus, a terminal, a network side device, and a readable storage medium.

### BACKGROUND

Waveform switching is an uplink enhancement technology applied to a wireless communication system. Based on a dynamic switching technology between a cyclic prefix orthogonal frequency division multiplexing (CP-OFDM) waveform and a discrete Fourier transform-spread orthogonal frequency division multiplexing (DFT-S-OFDM) waveform, a terminal may select, under a corresponding channel status condition, a proper waveform for transmission.

In a related technology, the terminal can only perform transmission based on an existing waveform configuration, causing low performance of the terminal.

### SUMMARY

Embodiments of this application provide an information transmission method and apparatus, a terminal, a network side device, and a readable storage medium.

According to a first aspect, an information transmission method is provided. The method includes:
receiving, by a terminal, first signaling sent by a network side device, where the first signaling includes at least one of the following:
first indication information, indicating the terminal to switch a transmission waveform; and
waveform information, used for determining information about a target transmission waveform.

According to a second aspect, an information transmission method is provided. The method includes:
sending, by a network side device, first signaling to a terminal, where the first signaling includes at least one of the following:
first indication information, indicating the terminal to switch a transmission waveform; and
waveform information, used for determining information about a target transmission waveform.

According to a third aspect, an information transmission apparatus is provided, used in a terminal, and including:
a receiving module, configured to receive first signaling sent by a network side device, where the first signaling includes at least one of the following:
first indication information, indicating the terminal to switch a transmission waveform; and
waveform information, used for determining information about a target transmission waveform.

According to a fourth aspect, an information transmission apparatus is provided, used in a network side device, and including:
a sending module, configured to send first signaling to a terminal, where the first signaling includes at least one of the following:
first indication information, indicating the terminal to switch a transmission waveform; and
waveform information, used for determining information about a target transmission waveform.

According to a fifth aspect, a terminal is provided. The terminal includes a processor, a memory, and a program or instructions stored in the memory and executable on the processor, the program or the instructions, when executed by the processor, implementing steps of the method according to the first aspect.

According to a sixth aspect, a terminal is provided, including a processor and a communication interface. The communication interface is configured to receive first signaling sent by a network side device. The first signaling includes at least one of the following: first indication information, indicating the terminal to switch a transmission waveform; and waveform information, used for determining information about a target transmission waveform.

According to a seventh aspect, a network side device is provided. The network side device includes a processor, a memory, and a program or instructions stored in the memory and executable on the processor, the program or the instructions, when executed by the processor, implementing steps of the method according to the second aspect.

According to an eighth aspect, a network side device is provided, including a processor and a communication interface. The communication interface is configured to send first signaling to a terminal. The first signaling includes at least one of the following:
first indication information, indicating the terminal to switch a transmission waveform; and
waveform information, used for determining information about a target transmission waveform.

According to a ninth aspect, a readable storage medium is provided. The readable storage medium stores a program or instructions, the program or the instructions, when executed by a processor, implementing steps of the method according to the first aspect, or implementing steps of the method according to the second aspect.

According to a tenth aspect, a chip is provided. The chip includes a processor and a communication interface. The communication interface is coupled to the processor, and the processor is configured to execute a program or instructions, to implement the method according to the first aspect, or implement the method according to the second aspect.

According to an eleventh aspect, a computer program/program product is provided. The computer program/program product is stored in a non-transitory storage medium. The computer program/program product is executed by at least one processor to implement steps of the method according to the first aspect, or implement steps of the method according to the second aspect.

### BRIEF DESCRIPTION OF THE DRAWINGS

FIG. 1 is a schematic structural diagram of a wireless communication system according to an embodiment of this application;

FIG. 2 is a schematic flowchart 1 of an information transmission method according to an embodiment of this application;

FIG. 3 is a schematic diagram of carrying first indication information and/or waveform information in an FDRA domain in DCI according to an embodiment of this application;

FIG. 4 is a schematic flowchart 2 of an information transmission method according to an embodiment of this application;

FIG. 5 is a schematic structural diagram 1 of an information transmission apparatus according to an embodiment of this application;

FIG. 6 is a schematic structural diagram 2 of an information transmission apparatus according to an embodiment of this application;

FIG. 7 is a schematic structural diagram 1 of a terminal according to an embodiment of this application;

FIG. 8 is a schematic structural diagram 2 of a terminal according to an embodiment of this application;

FIG. 9 is a schematic structural diagram 1 of a network side device according to an embodiment of this application; and

FIG. 10 is a schematic structural diagram 2 of a network side device according to an embodiment of this application.

### DETAILED DESCRIPTION

The following clearly describes the technical solutions in embodiments of this application with reference to the accompanying drawings in the embodiments of this application. Apparently, the described embodiments are merely some but not all of the embodiments of this application. All other embodiments obtained by a person of ordinary skill in the art based on the embodiments of this application fall within the protection scope of this application.

In the specification and claims of this application, terms “first”, “second”, and the like are used to distinguish similar objects, but do not indicate a particular sequence or order. It should be understood that, the terms used in this way is exchangeable in a proper case, so that the embodiments of this application can be implemented in another order other than those shown or described herein. The objects distinguished by “first” and “second” are usually of a same type, and a number of objects is not limited. For example, the first object may be one or more. In addition, “and/or” in this specification and the claims represents at least one of the connected objects, and the character “/” generally indicates an “or” relationship between the associated objects.

The technologies described in the embodiments of this application are not limited to a Long Term Evolution (LTE)/LTE-advanced (LTE-A) system, and may further be applied to various wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and other systems. Terms “system” and “network” in the embodiments of this application may usually be used interchangeably. The technology described in this application may be applied to the systems and radio technologies mentioned above, and may also be applied to other systems and radio technologies. The following description describes a New Radio (NR) system for an example purpose, and NR terminology is used in much of the following description, but these techniques may also be applied to applications other than NR system applications, such as a 6th Generation (6G) communication system.

FIG. 1 is a schematic structural diagram of a wireless communication system according to an embodiment of this application. As shown in FIG. 1, the wireless communication system includes: a terminal 11 and a network side device 12. The terminal 11 may also be referred to as a terminal device or a user equipment (UE). The terminal 11 may be terminal side devices such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR) or a virtual reality (VR) device, a robot, a wearable device, a vehicle user equipment (VUE), a pedestrian user equipment (PUE), a smart household (household devices with a wireless communication function, such as a refrigerator, a television, a washing machine, or furniture). The wearable devices include: a smart watch, a smart bracelet, a smart earphone, smart glasses, smart jewelry (a smart bangle, a smart wrist chain, a smart ring, a smart necklace, a smart anklet, a smart ankle chain, and the like), a smart wristband, smart clothes, a game console, and the like. It should be noted that in the embodiments of this application, a specific type of the terminal 11 is not limited. The network side device 12 may be a base station or a core network. The base station may be referred to as an access point, a base transceiver station (BTS), a radio base station, a radio transceiver, a basic service set (BSS), a NodeB, an evolved NodeB (eNB), a home NodeB, a home evolved NodeB, a WLAN access point, a Wi-Fi node, a transmitting receiving point (TRP), or another proper term in the field. As long as a same technical effect is implemented, the base station is not limited to a specific technical term. It should be noted that, the base station in the NR system is only used as an example in the embodiments of this application, but a specific type of the base station is not limited.

The information transmission method provided in the embodiments of this application is described in detail below by using some embodiments and application scenarios thereof with reference to the accompanying drawings.

The embodiments of this application provide an information transmission method. The information transmission method may be applied to a wireless communication system supporting dynamic waveform switching. A terminal supports the dynamic waveform switching. After receiving first signaling sent by a network side device, the terminal can learn a waveform switching indication and/or a switched waveform by parsing the first signaling. Then the terminal may perform dynamic waveform switching based on the waveform switching indication and/or the switched waveform, and perform uplink transmission by using the switched waveform, so that transmission performance of the terminal can be effectively improved.

For example, the network side device may indicate the terminal to perform uplink transmission by using a CP-OFDM waveform with a higher transmission rate. However, in some cases, for example, when the terminal is located at an edge position of a cell, to effectively ensure service transmission performance, the network side device sends a dynamic switching indication or the switched waveform to the terminal in real time, and the terminal switches from the CP-OFDM waveform to a DFT-S-OFDM waveform, and performs the uplink transmission by using the DFT-S-OFDM waveform.

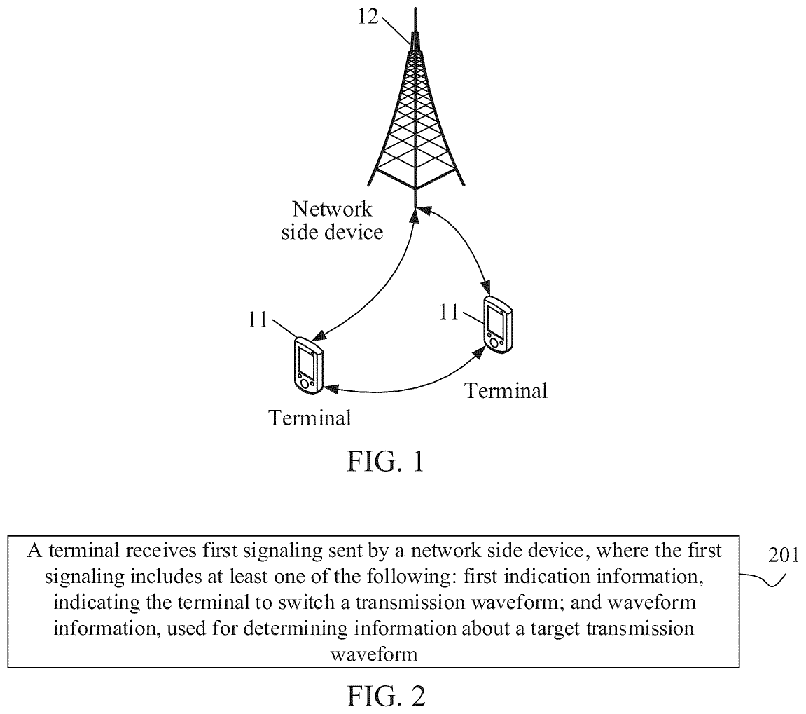

FIG. 2 is a schematic flowchart 1 of an information transmission method according to an embodiment of this application. As shown in FIG. 2, the method includes the following steps.

Step 201. A terminal receives first signaling sent by a network side device. The first signaling includes at least one of the following: first indication information, indicating the terminal to switch a transmission waveform; and waveform information, used for determining information about a target transmission waveform.

It should be noted that this embodiment of this application may be applied to a wireless communication system supporting waveform switching. The terminal includes, but is not limited to, the types of the terminal 11 listed above. The network side device includes, but is not limited to, the types of the network side device 12 listed above. This is not limited in this application. In this embodiment of this application, the first signaling may include only the first indication information or the waveform information, or may include both the first indication information and the waveform information.

Optionally, the first signaling may include downlink control information (DCI); and the DCI includes the first indication information and/or the waveform information.

Optionally, the target transmission waveform may include: a CP-OFDM waveform or a DFT-S-OFDM waveform. The target transmission waveform may be a switched waveform indicated by the network side device. It may be understood that the target transmission waveform may be a waveform used in a PUSCH used by the terminal to send uplink data to the network side device, or may be a waveform used in a physical sidelink shared channel (PSSCH) for performing sidelink communication between terminals.

An example in which the target transmission waveform is the DFT-S-OFDM waveform is used. In a case that the terminal performs the uplink transmission by using the CP-OFDM waveform, when receiving the first signaling that carries the DFT-S-OFDM waveform and that is sent by the network side device, the terminal performs the dynamic waveform switching, and switches from the CP-OFDM waveform to the DFT-S-OFDM waveform to perform the uplink transmission.

Optionally, first indication information indicates the terminal to switch a transmission waveform, in other words, the first indication information indicates the terminal to dynamically switch from a current waveform to another waveform.

An example in which the current waveform is the DFT-S-OFDM waveform, and the another waveform is the CP-OFDM waveform is used for description below. In a case that the terminal performs the uplink transmission by using the DFT-S-OFDM waveform, when receiving the first signaling that carries the first indication information and that is sent by the network side device, the terminal performs the dynamic waveform switching, and switches from the DFT-S-OFDM waveform to the CP-OFDM waveform to perform the uplink transmission.

In the information transmission method provided in this embodiment of this application, after receiving the first signaling sent by the network side device, the terminal can learn the waveform switching indication and/or the switched waveform by parsing the first signaling. Then the terminal may perform the dynamic waveform switching based on the waveform switching indication and/or the switched waveform, and perform the uplink transmission by using the switched waveform, so that transmission performance of the terminal can be effectively improved.

Optionally, after the terminal receives the first signaling sent by the network side device, the terminal determines a target resource allocation manner and a size of a frequency domain resource allocation (FDRA) domain in the DCI based on the first signaling. Then the terminal transmits, by using a frequency domain resource determined based on the target resource allocation manner and the size of the FDRA domain, a signal satisfying the target transmission waveform.

For example, in a case that the network side device uses an existing information domain in the DCI, for example, in a case that the FDRA domain carries the first indication information and/or the waveform information, to support a frequency domain resource allocation requirement of the CP-OFDM waveform and the DFT-S-OFDM waveform, in addition to carrying the first indication information and/or the waveform information in the FDRA domain, the network side device further needs to indicate, in the FDRA domain, frequency domain resource configuration information of the target transmission waveform (that is, the switched waveform). In this case, the terminal needs to determine the size of the FDRA domain in the DCI, so that the terminal and the network side device have consistent understanding of content and the size of the FDRA domain, to support dynamic transmission waveform switching, and effectively improve the transmission performance of the terminal.

An implementation solution in which the terminal determines, in a dynamic waveform switching scenario, the size of the FDRA domain in the DCI and the target resource allocation manner actually used by the terminal is described below.

1. An implementation in which the terminal determines, in the dynamic waveform switching scenario, the target resource allocation manner actually used by the terminal may include any one of the following manners:

Manner 1: The network side device indicates, through a MAC CE message, the target resource allocation manner actually used by the terminal.

Manner 2: The first signaling further includes the target resource allocation manner. To be specific, in addition to the first indication information and/or the waveform information, the first signaling sent by the network side device to the terminal further carries the target resource allocation manner actually used by the terminal.

Specifically, in a case that the first signaling includes the target resource allocation manner, the terminal parses the first signaling, to obtain the target resource allocation manner.

Manner 3: The terminal determines, based on the target transmission waveform indicated by the network side device, the target resource allocation manner actually used by the terminal.

2. An implementation in which the terminal determines the target resource allocation manner and the size of the FDRA domain in the DCI based on the first signaling may include any one of the following manners:

Specifically, the terminal learns, by parsing the first signaling, that the network side device indicates the terminal to perform the dynamic waveform switching, and further determines the target resource allocation manner and the size of the FDRA domain in the DCI. In practice, the implementation in which the terminal determines the target resource allocation manner and the size of the FDRA domain in the DCI based on the first signaling may include any one of the following manners.

Manner a. The terminal determines, in a case that the first signaling is received, that the target resource allocation manner is a first resource allocation manner, where the first resource allocation manner is a resource allocation manner in which resources are continuous; and the terminal determines that the size of the FDRA domain is a first reference value.

In Manner a, in a case of configuring the dynamic waveform switching, the network side device configures both types of waveforms (for example, the CP-OFDM waveform and the DFT-S-OFDM waveform) in a first resource allocation manner. To be specific, the resource allocation manner configured by the network side device is the first resource allocation manner, where the first resource allocation manner is the resource allocation manner in which resources are continuous. For example, the first resource allocation manner may be an uplink frequency spectrum resource allocation manner 1 (that is, a type 1). In this case, by sending the first signaling to the terminal, the network side device may implicitly indicate to the terminal that the resource allocation manner configured by the network side device is the first resource allocation manner.

In a case of receiving the first signaling, when learning, based on the first signaling, that the network side device indicates the terminal to perform the dynamic waveform switching, the terminal directly determines that the target resource allocation manner is the first resource allocation manner; and the terminal determines that the size of the FDRA domain is a first reference value. The target resource allocation manner refers to an uplink spectrum resource allocation manner actually used by the terminal.

For example, in a case that the first resource allocation manner is the type 1, the first reference value may be ┌log₂(N_{RB}^{UL,BWP}(N_{RB}^{UL,BWP}+1)/2)┐, where N_{RB}^{UL,BWP} represents a number of resource blocks (RBs) included in an uplink bandwidth part (BWP).

Manner b. The terminal determines the target transmission waveform based on the first signaling, and then determines the target resource allocation manner and the size of the FDRA domain in the DCI based on the target transmission waveform.

In Manner b, resource allocation manners configured by the network side device for different waveforms (for example, the CP-OFDM waveform and the DFT-S-OFDM waveform) may be different. Specifically, the terminal may determine the target transmission waveform based on the first signaling, obtains the resource allocation manner configured by the network side device, and then determines the target resource allocation manner and the size of the FDRA domain in the DCI based on both the target transmission waveform and the resource allocation manner configured by the network side device. The target resource allocation manner refers to an uplink spectrum resource allocation manner actually used by the terminal.

In this embodiment of this application, an implementation in which the terminal determines the target resource allocation manner and the size of the FDRA domain in the DCI based on the target transmission waveform may include any one of the following manners:

Manner 1: In a case that the resource allocation manner configured by the network side device is a second resource allocation manner, and the target transmission waveform includes the CP-OFDM waveform, the terminal determines that the target resource allocation manner is the second resource allocation manner, and determines that the size of the FDRA domain is a second reference value, where the second resource allocation manner is a resource allocation manner in which resources are not continuous.

In the embodiments of this application, the second resource allocation manner is the resource allocation manner in which resources are not continuous. For example, the second resource allocation manner is a resource allocation manner 0 (that is, a type 0). In a case that the resource allocation manner configured by the network side device is the type 0 (or the resource allocation manner configured by the network side device is dynamic switching, but the resource allocation manner indicated by the DCI is the type 0), and the target transmission waveform is the CP-OFDM waveform, that is, the network side device indicates the terminal to switch from the DFT-S-OFDM waveform to the CP-OFDM waveform to perform the uplink transmission switching, or the network side device indicates the terminal to perform the uplink transmission by using the CP-OFDM waveform, the terminal determines that the target resource allocation manner is the second resource allocation manner, and determines that the size of the FDRA domain is the second reference value. For example, the second reference value is N_{RBG}, where N_{RBG} is a number of resource block groups (RBGs). After the waveform is switched to the CP-OFDM waveform, when performing CP-OFDM waveform mapping, the terminal may actually perform mapping in the second resource allocation manner (for example, the type 0), to support CP-OFDM. Optionally, after the waveform is switched to the CP-OFDM waveform, when performing the CP-OFDM waveform mapping, the terminal may alternatively perform the mapping in the first resource allocation manner (for example, the type 1).

Manner 2: In a case that the resource allocation manner configured by the network side device is a second resource allocation manner, and the target transmission waveform includes the DFT-S-OFDM waveform, the terminal determines that the target resource allocation manner is the first resource allocation manner, and determines that the size of the FDRA domain is a third reference value, where the third reference value is greater than the second reference value.

An example in which the second resource allocation manner is the type 0 is used for description. In a case that the resource allocation manner configured by the network side device is the type 0 (or the resource allocation manner configured by the network side device is dynamic switching, but the resource allocation manner indicated by the DCI is the type 0), and the target transmission waveform is the DFT-S-OFDM waveform, the terminal needs to switch from using the CP-OFDM waveform to using the DFT-S-OFDM waveform, and determines that the size of the FDRA domain is the third reference value; and the size of the FDRA domain needs to be extended from the second reference value to the third reference value. In this case, the terminal determines that the target resource allocation manner is the first resource allocation manner. After the waveform is switched to the DFT-S-OFDM waveform, when performing DFT-S-OFDM waveform mapping, the terminal actually performs the mapping in the first resource allocation manner (for example, the type 1), to support DFT-S-OFDM. For example, the third reference value may be max(┌log₂(N_{RB}^{UL,BWP}(N_{RB}^{UL,BWP}+1)/2)┐,N_{RBG})+1, where N_{RB}^{UL,BWP} represents a number of RBs included in the uplink BWP, and N_{RBG} represents a number of RBGs.

Manner 3: In a case that the resource allocation manner configured by the network side device is the first resource allocation manner, the terminal determines that the target resource allocation manner is the first resource allocation manner, and determines that the size of the FDRA domain is the first reference value.

An example in which the first resource allocation manner is the type 1 is used for description. In a case that the resource allocation manner configured by the network side device is the type 1, the terminal determines that the target resource allocation manner is the first resource allocation manner, and the terminal determines, based on the type 1, that the size of the FDRA domain is the first reference value. For example, the first reference value is ┌log₂(N_{RB}^{UL,BWP}(N_{RB}^{UL,BWP}+1)/2)┐, where N_{RB}^{UL,BWP} represents a number of RBs included in the uplink BWP.

Manner 4: In a case that the resource allocation manner configured by the network side device is the dynamic switching, the terminal determines that the size of the FDRA domain is the third reference value; and the terminal determines the target resource allocation manner based on the size of the FDRA domain.

Optionally, in a case that the resource allocation manner configured by the network side device is the dynamic switching, the terminal determines the target resource allocation manner through a specific FDRA size in the DCI or a DCI setting field. In this case, to ensure that the terminal can support two types of waveforms at the same time, the size (FDRA size) of the FDRA domain may be the third reference value. For example, the third reference value may be max(┌log₂(N_{RB}^{UL,BWP}(N_{RB}^{UL,BWP}+1)/2)┐,N_{RBG})+1, where N_{RB}^{UL,BWP} represents a number of RBs included in the uplink BWP, and N_{RBG} represents a number of RBGs.

Manner 5: In a case that the target transmission waveform includes the DFT-S-OFDM waveform, and the resource allocation manner configured by the network side device is a third resource allocation manner, the terminal determines that the target resource allocation manner is the first resource allocation manner, and determines that the size of the FDRA domain is a fourth reference value, where the third resource allocation manner is a resource allocation manner that is based on an unauthorized frequency band.

In the embodiments of this application, the third resource allocation manner is a resource allocation manner that is based on an unauthorized frequency band. For example, the third resource allocation manner is a resource allocation manner 2 (that is, a type 2). The type 2 may be a mapping manner of a New Radio Unlicensed spectrum (NRU).

Specifically, in a case that the resource allocation manner configured by the network side device is the type 2, and the target transmission waveform is the DFT-S-OFDM waveform, when the terminal needs to switch from using the CP-OFDM waveform to using the DFT-S-OFDM waveform, the terminal determines that the size of the FDRA domain is the fourth reference value, and determines that the target resource allocation manner is the first resource allocation manner. In other words, the terminal may perform the mapping in the first resource allocation manner (for example, the type 1, or may be another resource allocation manner in which resources are continuous), to implement the support of the DFT-S-OFDM.

The fourth reference value is a largest value in the third reference value and a fifth reference value, where the fifth reference value may be obtained through calculation by using the following formula (1) or formula (2):

$$D = 5 + Y \qquad ( 1 )$$

$$D = 6 + Y \qquad ( 2 )$$

D is the fifth reference value, and

$$Y = {log}_{2} ( \frac{{N}_{RB - set , UL}^{BWP} ( {N}_{RB - set , UL}^{BWP} + 1 )}{2} ) ,$$

where N_{RB-set,UL}^{BWP} is a number of RBs in a RB set included in an uplink BWP on an unauthorized frequency band.

In this embodiment of this application, at least M least significant bits (LSBs) or most significant bits (MSBs) are reserved in each FDRA domain, used for specific FDRA resource block indication, that is, indicating frequency domain resource allocation information. In practice, after determining the size of the FDRA domain in the DCI based on the target transmission waveform and the target resource allocation manner configured by the network side device, the terminal obtains, based on information about M LSBs or MSBs in the FDRA domain, frequency domain resource allocation information indicated by the FDRA domain.

Optionally, in a case of enabling the waveform switching, the terminal does not expect to configure a resource allocation manner 0 supporting a CP-OFDM waveform. In other words, the terminal does not expect to configure the type 0 for the CP-OFDM waveform after enabling a waveform switching function.

In the embodiments of this application, the first signaling may include the DCI. An implementation of carrying the first indication information and/or the waveform information in the DCI may include at least one of the following:
(a) An additional new domain in the DCI includes the first indication information and/or the waveform information. Specifically, an information domain or an information field is added to the DCI. For example, a waveform switch domain of at least one bit is added to the DCI. The added information domain carries the first indication information and/or the waveform information, and indicates enabling of the waveform switching.
(b) A target domain in the DCI includes the first indication information and/or the waveform information. The target domain refers to an existing information domain or an existing information field in the DCI. Specifically, the target domain may include at least one of the following: an FDRA domain, an antenna port domain, and a transmitted precoding matrix indicator (TPMI) domain.

An implementation of the target domain in the embodiments of this application is described below by using an example.

Manner 1: In a case that the target domain in the DCI includes the FDRA domain, the FDRA domain may include N1 bits and N2 bits, where the N1 bits are used to carry the first indication information and/or the waveform information; and the N2 bits indicate frequency domain resource configuration information of the target transmission waveform.

A bit number of the N1 bits is N1, and a bit number of the N2 bits is N2, where both N1 and N2 are integers greater than or equal to 1. The N1 bits may be N1 bits of LSBs in the FDRA domain, or may be N1 bits of MSBs in the FDRA domain, or may be any N1 bits. Optionally, N1 bits are fewer than N2 bits. The N2 bits may be at least one bit other than the N1 bits in the FDRA domain.

For example, the network side device configures the N1 bits in the FDRA domain, and the first indication information and/or the waveform information are carried in the N1 bits, to indicate the waveform switching or indicate the switched waveform, so that the terminal switches the waveform to the CP-OFDM waveform or the DFT-S-OFDM waveform. The network side device configures the N2 bits in the FDRA domain, and the frequency domain resource configuration information of the target transmission waveform is carried in the N2 bits, to indicate information such as allocation of a specific number of physical resource blocks (PRBs) of the frequency domain resource.

To support the frequency domain resource allocation requirement for the CP-OFDM waveform and the DFT-S-OFDM waveform, the size of FDRA domain needs to be extended in Manner 1. For example, a bit number of the FDRA domain may be N_{RBG} or ┌log₂(N_{RB}^{UL,BWP}(N_{RB}^{UL,BWP}+1)/2)┐. N_{RBG} represents the number of RBGs, and N_{RB}^{UL,BWP} represents the number of RBs included in the uplink BWP.

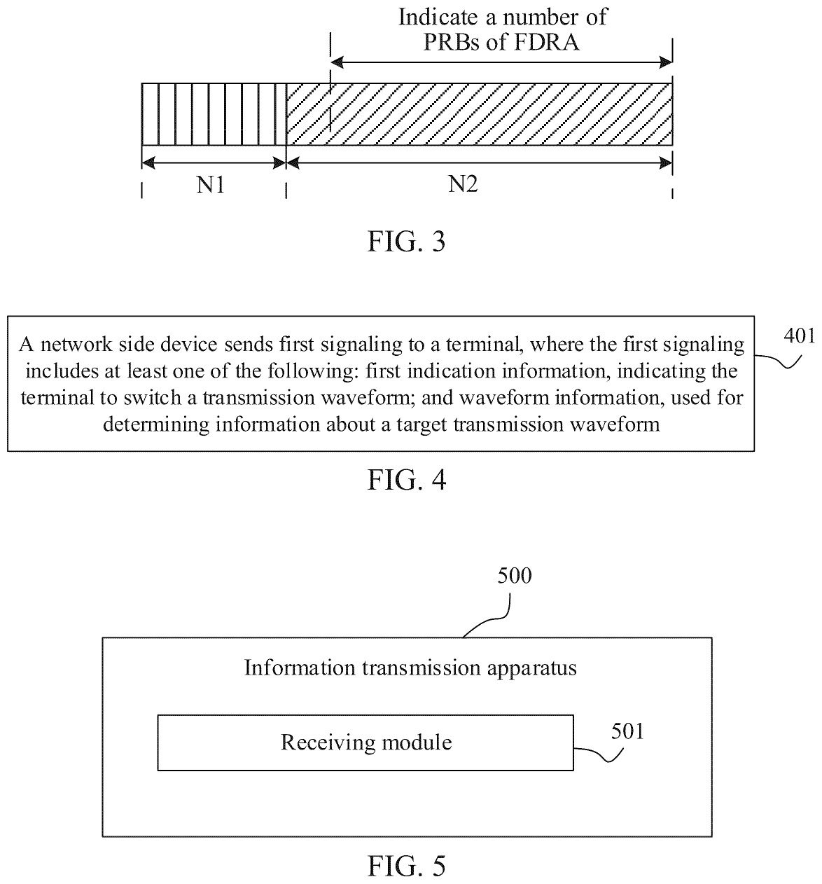

FIG. 3 is a schematic diagram of carrying first indication information and/or waveform information in an FDRA domain in DCI according to an embodiment of this application; As shown in FIG. 3, first N1 bits in the FDRA domain may indicate the waveform switching or the switched waveform, and the N2 bits indicate the frequency domain resource configuration information of the switched waveform, and can support a frequency domain resource required by the switched waveform.

Manner 2: In a case that the target domain in the DCI includes the antenna port domain, the antenna port domain includes N3 bits and N4 bits, where the N3 bits are used to carry the first indication information and/or the waveform information; and the N4 bits indicate antenna port configuration information corresponding to the target transmission waveform.

A bit number of the N3 bits is N3, and a bit number of the N4 bits is N4, where both N3 and N4 are integers greater than or equal to 1. To support the dynamic waveform switching, a reserve bit in the antenna port domain may be reused. The N3 bits and the N4 bits may be reserved bits in the antenna port domain in the DCI. The reserve bit in the antenna port domain is used to carry the first indication information and/or the waveform information, and antenna port configuration information corresponding to the target transmission waveform. The first indication information and/or the waveform information indicate the waveform switching or indicate the switched waveform, and the antenna port configuration information corresponding to the target transmission waveform indicates an antenna port number corresponding to the switched waveform, so that the terminal switches the waveform to the CP-OFDM waveform or the DFT-S-OFDM waveform.

For example, the network side device configures the N3 bits in the antenna port, and the first indication information and/or the waveform information are carried in the N3 bits, to indicate the waveform switching or indicate the switched waveform, so that the terminal switches the waveform to the CP-OFDM waveform or the DFT-S-OFDM waveform. The network side device configures the N4 bits in the antenna port domain, and the corresponding antenna port configuration information is carried in the N4 bits, to indicate the antenna port number.

An example is used for describing the reserve bit in the antenna port domain. For a CP-OFDM waveform with a demodulation reference signal (DMRS) type=1, a maximum length (maxlength)=2, and a rank=3, an indication manner of the CP-OFDM waveform is shown in Table 1.

TABLE 1

| | Number of DMRS | | |
|---|---|---|---|
| | CDM group(s) | | Number of front-load |
| Value | without data | DMRS port(s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

In this embodiment of this application, two bits of the reserve bits in the antenna port domain indicate that the waveform is switched to the DFT-S-OFDM waveform or indicate the switched waveform and a waveform configuration. Optionally, if the DFT-S-OFDM waveform needs to be switched back to the CP-OFDM waveform, a change of layer mapping information is used for implicitly indicating switching, and a bit other than the reserve bits in the antenna port domain indicates a configuration.

The Value represents a value of the information domain indicated by the DMRS port; the Number of DMRS CDM group(s) without data represents a number of DMRS CDM groups without data; the DMRS port(s) represents a set of the DMRS ports; and the Number of front-load symbols represents a number of front-loaded DMRS symbols.

Manner 3: In a case that the target domain in the DCI includes the TPMI domain, the TPMI domain includes N5 bits, where the N5 bits are used to carry the first indication information and/or the waveform information.

A bit number of the N5 bits is N5, where N5 is an integer greater than or equal to 1.

Optionally, the TPMI domain includes layer information of a signal and information about the target transmission waveform corresponding to precoding information. In practice, the TPMI domain in the DCI may be extended, and bits obtained through extension are used as the N5 bits. The N5 bits obtained through extension in the TPMI are used to carry the first indication information and/or the waveform information, indicating the waveform switching or indicating the switched waveform, so that the terminal switches a currently used waveform from the CP-OFDM waveform to the DFT-S-OFDM waveform, or from the DFT-S-OFDM waveform to the CP-OFDM waveform.

Manner 4: In a case that the target domain in the DCI includes the TPMI domain, an indication of the TPMI domain is reused for predefining which waveform is used in the configuration at a position at which the CP-OFDM waveform and the DFT-S-OFDM waveform configurations are supported in a manner of adding a column in a TPMI table. Table 2 is used as an example, and the CP waveform at four ports is used as an example. For a configuration supporting both the CP-OFDM waveform and the DFT-S-OFDM waveform, a column is added to Table 2 for indicating the waveform switching or indicating a waveform configuration of the switched waveform.

For example, in a case that a code point/an index is 000001, if a corresponding waveform configuration is the DFT waveform, the DFT waveform is used; and if the terminal currently uses the CP waveform, the waveform switching is indicated.

TABLE 2

| Bit field | | |
|---|---|---|
| mapped to | codebookSubset = | |
| index | fullyAndPartialAndNonCoherent | Waveform |
| 0 | 1 layer: TPMI = 0 | CP |
| 1 | 1 layer: TPMI = 1 | DFT |
| . . . | . . . | — |
| 3 | 1 layer: TPMI = 3 | CP |
| 4 | 2 layers: TPMI = 0 | — |
| . . . | . . . | — |
| 9 | 2 layers: TPMI = 5 | — |
| 10 | 3 layers: TPMI = 0 | — |
| 11 | 4 layers: TPMI = 0 | — |
| 12 | 1 layer: TPMI = 4 | DFT |
| . . . | . . . | — |
| 19 | 1 layer: TPMI = 11 | CP |
| 20 | 2 layers: TPMI = 6 | — |
| . . . | . . . | — |
| 27 | 2 layers: TPMI = 13 | — |
| 28 | 3 layers: TPMI = 1 | — |
| 29 | 3 layers: TPMI = 2 | — |
| 30 | 4 layers: TPMI = 1 | — |
| 31 | 4 layers: TPMI = 2 | — |
| 32 | 1 layers: TPMI = 12 | DFT |
| . . . | . . . | — |
| 47 | 1 layers: TPMI = 27 | CP |
| 48 | 2 layers: TPMI = 14 | — |
| . . . | . . . | — |
| 55 | 2 layers: TPMI = 21 | — |
| 56 | 3 layers: TPMI = 3 | — |
| . . . | . . . | — |
| 59 | 3 layers: TPMI = 6 | — |
| 60 | 4 layers: TPMI = 3 | — |
| 61 | 4 layers: TPMI = 4 | — |
| 62-63 | reserved | |

FIG. 4 is a schematic flowchart 2 of an information transmission method according to an embodiment of this application. As shown in FIG. 4, the method includes the following steps.

Step 401. A network side device sends first signaling to a terminal, where the first signaling includes at least one of the following: first indication information, indicating the terminal to switch a transmission waveform; and waveform information, used for determining information about a target transmission waveform.

It should be noted that this embodiment of this application may be applied to a wireless communication system supporting waveform switching. The terminal includes, but is not limited to, the types of the terminal 11 listed above. The network side device includes, but is not limited to, the types of the network side device 12 listed above. This is not limited in this application. In this embodiment of this application, the first signaling may include only the first indication information or the waveform information, or may include both the first indication information and the waveform information.

In the information transmission method provided in the embodiments of this application, the network side device does not need to perform RRC reconfiguration when the waveform switching is required, but sends a waveform switching indication and/or the switched waveform to the terminal through the first signaling. The terminal performs dynamic waveform switching based on the waveform switching indication and/or the switched waveform, and may further perform uplink transmission by using the switched waveform, so that transmission performance of the terminal can be effectively improved.

Optionally, a target resource allocation manner configured by the network side device for the terminal may be a first resource allocation manner, where the first resource allocation manner is a resource allocation manner in which resources are continuous. In practice, when configuring the dynamic waveform switching, the network side device configures both types of waveforms (for example, a CP-OFDM waveform and a DFT-S-OFDM waveform) in the first resource allocation manner, for example, a type 1. In this case, by sending the first signaling to the terminal, the network side device implicitly indicates to the terminal that the first resource allocation manner is used for the target transmission waveform. In a case of receiving the first signaling, the terminal may directly determine that the target resource allocation manner is the first resource allocation manner, and the terminal further determines a size of an FDRA domain is a first reference value based on the first resource allocation manner.

It should be noted that the information transmission method provided in the embodiments of this application may be performed by an information transmission apparatus or a control module configured to perform the information transmission method in the information transmission apparatus. An example in which the information transmission apparatus performs the information transmission method is used in this embodiment of this application for describing the information transmission apparatus provided in the embodiments of this application. FIG. 5 is a schematic structural diagram 1 of an information transmission apparatus according to an embodiment of this application. As shown in FIG. 5, the information transmission apparatus 500 is used in a terminal, and includes:
a receiving module 501, configured to receive first signaling sent by a network side device, where the first signaling includes at least one of the following:
first indication information, indicating the terminal to switch a transmission waveform;
and waveform information, used for determining information about a target transmission waveform.

The information transmission apparatus provided in the embodiments of this application receives the first signaling sent by the network side device. The first signaling includes the first indication information indicating the terminal to switch a transmission waveform and/or waveform information used for determining information about the target transmission waveform. The terminal learns an uplink waveform switching indication and a switched waveform by parsing the first signaling, and then determines a size of an FDRA domain according to the switched waveform. The FDRA domain may indicate a frequency domain resource configuration of the switched waveform. In this way, dynamic switching of the transmission waveform is implemented, and transmission performance of the terminal can be effectively improved.

Optionally, the information transmission apparatus 500 further includes:
a determining module, configured to determine a target resource allocation manner and the size of the frequency domain resource allocation FDRA domain in downlink control information DCI based on the first signaling.

Optionally, the determining module is specifically configured to:
determine, in a case that the first signaling is received, that the target resource allocation manner is a first resource allocation manner, where the first resource allocation manner is a resource allocation manner in which resources are continuous; and
determine that the size of the FDRA domain is a first reference value.

Optionally, the determining module is specifically configured to:
determine the target transmission waveform based on the first signaling; and
determine the target resource allocation manner and the size of the FDRA domain in the DCI based on the target transmission waveform.

Optionally, the determining module is specifically configured to:
determine, in a case that a resource allocation manner configured by the network side device is a second resource allocation manner, and the target transmission waveform includes a cyclic prefix orthogonal frequency division multiplexing CP-OFDM waveform, that the target resource allocation manner is the second resource allocation manner, and determine that the size of the FDRA domain is a second reference value, where the second resource allocation manner is a resource allocation manner in which resources are not continuous; or
determine, in a case that a resource allocation manner configured by the network side device is a second resource allocation manner, and the target transmission waveform includes a discrete Fourier transform-spread orthogonal frequency division multiplexing DFT-S-OFDM waveform, that the target resource allocation manner is a first resource allocation manner, and determine that the size of the FDRA domain is a third reference value, where the third reference value is greater than the second reference value.

Optionally, the determining module is specifically configured to determine, in a case that the resource allocation manner configured by the network side device is the first resource allocation manner, that the target resource allocation manner is the first resource allocation manner, and determine that the size of the FDRA domain is the first reference value.

Optionally, the determining module is specifically configured to determine, in a case that the resource allocation manner configured by the network side device is dynamic switching, that the size of the FDRA domain is the third reference value; and
determine the target resource allocation manner based on the size of the FDRA domain.

Optionally, the determining module is specifically configured to determine, in a case that the target transmission waveform includes the DFT-S-OFDM waveform, and the resource allocation manner configured by the network side device is the third resource allocation manner, that the target resource allocation manner is the first resource allocation manner, and determine that the size of the FDRA domain is a fourth reference value, where the third resource allocation manner is a resource allocation manner that is based on an unauthorized frequency band.

Optionally, the information transmission apparatus 500 further includes:
a transmission module, configured to transmit, by using a frequency domain resource determined based on the target resource allocation manner and the size of the FDRA domain, a signal satisfying the target transmission waveform.

Optionally, the information transmission apparatus 500 further includes:
an obtaining module, configured to obtain, based on information about M LSBs or MSBs in the FDRA domain, frequency domain resource allocation information indicated by the FDRA domain, where M is a positive integer.

Optionally, the first signaling includes the DCI. The DCI includes the first indication information and/or the waveform information.

Optionally, an additional new domain in the DCI includes the first indication information and/or the waveform information; or
a target domain in the DCI includes the first indication information and/or the waveform information.

Optionally, the target domain includes at least one of the following: an FDRA domain, an antenna port domain, and a transmitted precoding matrix indicator TPMI domain.

Optionally, in a case that the target domain includes the FDRA domain, the FDRA domain includes N1 bits and N2 bits, where the N1 bits are used to carry the first indication information and/or the waveform information; the N2 bits indicate frequency domain resource configuration information of the target transmission waveform; and N1 and N2 are both positive integers.

Optionally, in a case that the target domain includes the antenna port domain, the antenna port domain includes N3 bits and N4 bits, where the N3 bits are used to carry the first indication information and/or the waveform information; the N4 bits indicate antenna port configuration information corresponding to the target transmission waveform; and N3 and N4 are both positive integers.

Optionally, in a case that the target domain includes the TPMI domain, the TPMI domain includes N5 bits, where the N5 bits are used to carry the first indication information and/or the waveform information. N5 is a positive integer greater than or equal to 1.

Optionally, the TPMI domain includes layer information of a signal and information about the target transmission waveform corresponding to precoding information.

Optionally, the first signaling further includes: the target resource allocation manner.

Optionally, in a case of enabling the waveform switching, the terminal does not expect to configure a resource allocation manner 0 supporting the CP-OFDM waveform.

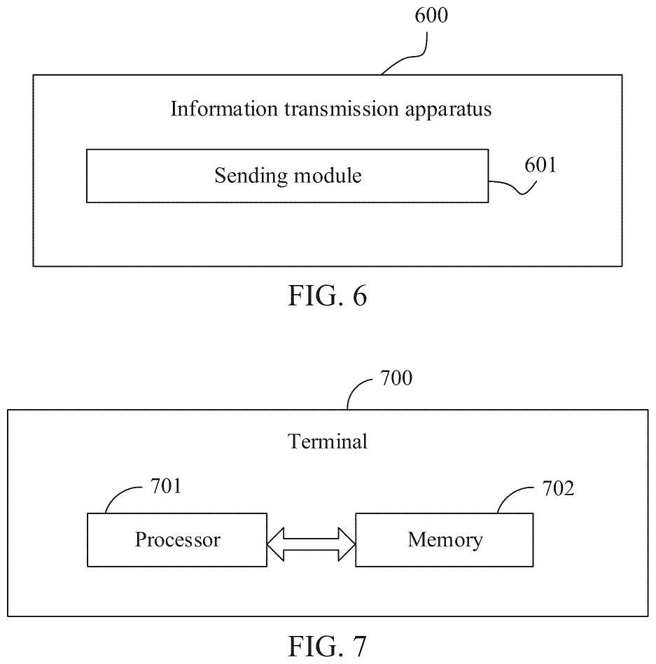

FIG. 6 is a schematic structural diagram 2 of an information transmission apparatus according to an embodiment of this application. As shown in FIG. 6, the information transmission apparatus 600 is used in a network side device, and includes:
a sending module 601, configured to send first signaling to a terminal, where the first signaling includes at least one of the following:
first indication information, indicating the terminal to switch a transmission waveform; and
waveform information, used for determining information about a target transmission waveform.

The information transmission apparatus provided in the embodiments of this application does not need to perform RRC reconfiguration when the waveform switching is required, but sends a waveform switching indication and/or the switched waveform to the terminal through the first signaling. The terminal performs dynamic waveform switching based on the waveform switching indication and/or the switched waveform, and may further perform uplink transmission by using the switched waveform, so that transmission performance of the terminal can be effectively improved.

Optionally, the information transmission apparatus 600 further includes:
a configuration module, configured to configure a first resource allocation manner as a target resource allocation manner for the terminal, where the first resource allocation manner is a resource allocation manner in which resources are continuous.

The information transmission apparatus in the embodiments of this application may be an apparatus, an apparatus or an electronic device having an operating system, or a component, an integrated circuit, or a chip in a terminal. The apparatus or the electronic device may be a mobile terminal, or may be a non-mobile terminal. For example, the mobile terminal may include, but is not limited to, the types of terminal 11 listed above. The non-mobile terminal may be a server, a Network Attached Storage (NAS), a personal computer (PC), a television (TV), a teller machine, a self-service machine, or the like. This is not specifically limited in the embodiments of this application.

The information transmission apparatus provided in the embodiments of this application can implement all processes implemented in the method embodiments of FIG. 2 to FIG. 4, and achieve the same technical effect. To avoid repetition, details are not described herein again.

FIG. 7 is a schematic structural diagram 1 of a terminal according to an embodiment of this application. As shown in FIG. 7, the terminal 700 provided in the embodiments of this application includes a processor 701, a memory 702, and a program or instructions stored in the memory 702 and executable on the processor 701. The program or the instructions, when executed by the processor 701, implement all processes of the embodiments of the information transmission method, and can achieve the same technical effect. To avoid repetition, details are not described herein again.

The embodiments of this application further provide a terminal, including a processor and a communication interface. The communication interface is configured to receive first signaling sent by a network side device, where the first signaling includes at least one of the following: first indication information, indicating the terminal to switch a transmission waveform; and waveform information, used for determining information about a target transmission waveform. The terminal embodiment corresponds to the method embodiments of the terminal side, and all implementation processes and implementations in the method embodiments can be used in the terminal embodiment, and can achieve the same technical effect.

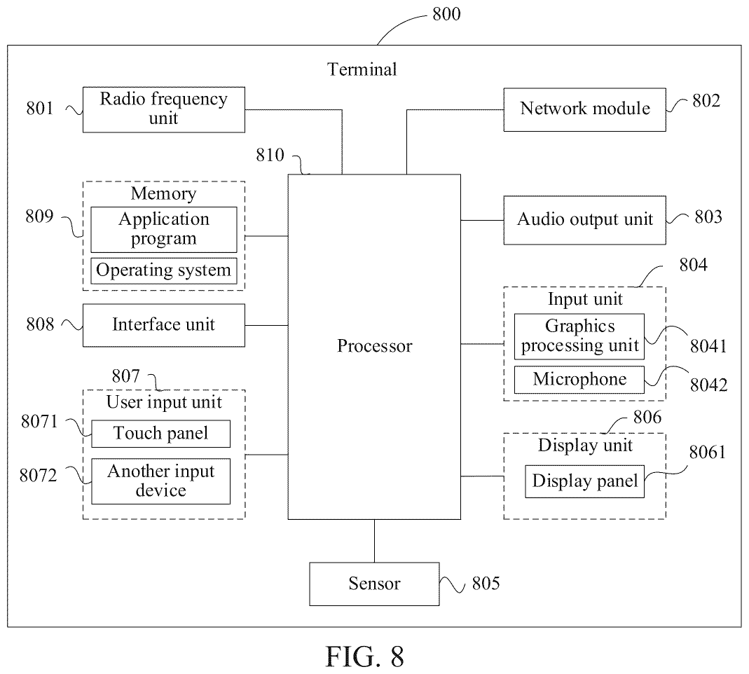

FIG. 8 is a schematic structural diagram 2 of a terminal according to an embodiment of this application. As shown in FIG. 8, a terminal 800 includes, but is not limited to: at least a part of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 may further include a power supply (such as a battery) for supplying power to the components. The power supply may be logically connected to the processor 810 by a power management system, thereby implementing functions such as charging, discharging, and power consumption management by using the power management system. The terminal structure shown in FIG. 8 does not constitute a limitation on the terminal, and the terminal may include more or fewer components than shown, or combine some components, or have different component arrangements, which are not described herein again.

It should be noted that in the embodiments of this application, the input unit 804 may include a graphics processing unit (GPU) 8041 and a microphone 8042. The graphics processing unit 8041 performs processing on image data of a static picture or a video that is obtained by an image acquisition device (for example, a camera) in a video acquisition mode or an image acquisition mode. The display unit 806 may include a display panel 8061, and the display panel 8061 may be configured by using a liquid crystal display, organic light-emitting diode, or the like. The user input unit 807 includes a touch panel 8071 and another input device 8072. The touch panel 8071 is also referred to as a touch screen. The touch panel 8071 may include two parts: a touch detection apparatus and a touch controller. The another input device 8072 may include, but is not limited to, a physical keyboard, a functional key (such as a volume control key or a switch key), a track ball, a mouse, and a joystick, which are not described herein again.

In the embodiments of this application, after receiving downlink data from a network side device, the radio frequency unit 801 delivers the downlink data to the processor 810 for processing; and further sends uplink data to the network side device. Generally, the radio frequency unit 801 includes, but is not limited to, an antenna, at least one amplifier, a transceiver, a coupler, a low noise amplifier, a duplexer, and the like.

The memory 809 may be configured to store a software program or instructions and various data. The memory 809 may mainly include a program or instructions storage area and a data storage area. The program or instructions storage area may store an operating system, an application program or instructions required by at least one function (for example, a sound playback function and an image display function), and the like. In addition, the memory 809 may include a high speed random access memory, or may include a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, for example, at least one magnetic disk storage device, a flash memory, or another non-volatile solid-state storage device.

The processor 810 may include one or more processing units. Optionally, the processor 810 may integrate an application processor and a modem, where the application processor mainly processes an operating system, a user interface, an application program or instructions, and the like, and the modem mainly processes wireless communication, for example, a baseband processor. It may be understood that, the modem may not be integrated into the processor 810.

The radio frequency unit 801 is configured to receive first signaling sent by a network side device, where the first signaling includes at least one of the following:
first indication information, indicating the terminal to switch a transmission waveform; and
waveform information, used for determining information about a target transmission waveform.

The terminal provided in the embodiments of this application receives the first signaling sent by the network side device. The first signaling includes the first indication information indicating the terminal to switch a transmission waveform and/or waveform information used for determining information about the target transmission waveform. The terminal learns an uplink waveform switching indication and a switched waveform by parsing the first signaling, and then determines a size of an FDRA domain according to the switched waveform. The FDRA domain may indicate a frequency domain resource configuration of the switched waveform. In this way, dynamic switching of the transmission waveform is implemented, and transmission performance of the terminal can be effectively improved.

Optionally, the processor 810 is configured to determine a target resource allocation manner and the size of the frequency domain resource allocation FDRA domain in downlink control information DCI based on the first signaling.

Optionally, the processor 810 is specifically configured to:
determine, in a case that the first signaling is received, that the target resource allocation manner is a first resource allocation manner, where the first resource allocation manner is a resource allocation manner in which resources are continuous; and
determine that the size of the FDRA domain is a first reference value.

Optionally, the processor 810 is specifically configured to:
determine the target transmission waveform based on the first signaling; and
determine the target resource allocation manner and the size of the FDRA domain in the DCI based on the target transmission waveform.

Optionally, the processor 810 is specifically configured to:
determine, in a case that a resource allocation manner configured by the network side device is a second resource allocation manner, and the target transmission waveform includes a cyclic prefix orthogonal frequency division multiplexing CP-OFDM waveform, that the target resource allocation manner is the second resource allocation manner, and determine that the size of the FDRA domain is a second reference value, where the second resource allocation manner is a resource allocation manner in which resources are not continuous; or
determine, in a case that a resource allocation manner configured by the network side device is a second resource allocation manner, and the target transmission waveform includes a discrete Fourier transform-spread orthogonal frequency division multiplexing DFT-S-OFDM waveform, that the target resource allocation manner is a first resource allocation manner, and determine that the size of the FDRA domain is a third reference value, where the third reference value is greater than the second reference value.

Optionally, the processor 810 is specifically configured to determine, in a case that the resource allocation manner configured by the network side device is the first resource allocation manner, that the target resource allocation manner is the first resource allocation manner, and determine that the size of the FDRA domain is the first reference value.

Optionally, the processor 810 is specifically configured to determine, in a case that the resource allocation manner configured by the network side device is dynamic switching, that the size of the FDRA domain is the third reference value; and
determine the target resource allocation manner based on the size of the FDRA domain.

Optionally, the processor 810 is specifically configured to determine, in a case that the target transmission waveform includes the DFT-S-OFDM waveform, and the resource allocation manner configured by the network side device is the third resource allocation manner, that the target resource allocation manner is the first resource allocation manner, and determine that the size of the FDRA domain is a fourth reference value, where the third resource allocation manner is a resource allocation manner that is based on an unauthorized frequency band.

Optionally, the radio frequency unit 801 is specifically configured to transmit, by using a frequency domain resource determined based on the target resource allocation manner and the size of the FDRA domain, a signal satisfying the target transmission waveform.

Optionally, the processor 810 is further configured to obtain, based on information about M LSBs or MSBs in the FDRA domain, frequency domain resource allocation information indicated by the FDRA domain, where M is a positive integer.

Optionally, the first signaling includes the DCI. The DCI includes the first indication information and/or the waveform information.

Optionally, an additional new domain in the DCI includes the first indication information and/or the waveform information; or
a target domain in the DCI includes the first indication information and/or the waveform information.

Optionally, the target domain includes at least one of the following: an FDRA domain, an antenna port domain, and a transmitted precoding matrix indicator TPMI domain.

Optionally, in a case that the target domain includes the FDRA domain, the FDRA domain includes N1 bits and N2 bits, where the N1 bits are used to carry the first indication information and/or the waveform information; the N2 bits indicate frequency domain resource configuration information of the target transmission waveform; and N1 and N2 are both positive integers.

Optionally, in a case that the target domain includes the antenna port domain, the antenna port domain includes N3 bits and N4 bits, where the N3 bits are used to carry the first indication information and/or the waveform information; and the N4 bits indicate antenna port configuration information corresponding to the target transmission waveform. N3 and N4 are both positive integers.

Optionally, in a case that the target domain includes the TPMI domain, the TPMI domain includes N5 bits, where the N5 bits are used to carry the first indication information and/or the waveform information. N5 is a positive integer greater than or equal to 1.

Optionally, the TPMI domain includes layer information of a signal and information about the target transmission waveform corresponding to precoding information.

Optionally, the first signaling further includes: the target resource allocation manner.

Optionally, in a case of enabling the waveform switching, the terminal does not expect to configure a resource allocation manner 0 supporting the CP-OFDM waveform.

The embodiments of this application further provide a network side device, including a processor and a communication interface. The communication interface is configured to send first signaling to a terminal, where the first signaling includes at least one of the following: first indication information, indicating the terminal to switch a transmission waveform; and waveform information, used for determining information about a target transmission waveform. The network side device embodiment corresponds to the method embodiments of the network side device, and all implementation processes and implementations in the method embodiments can be used in the network side device embodiment, and can achieve the same technical effect.

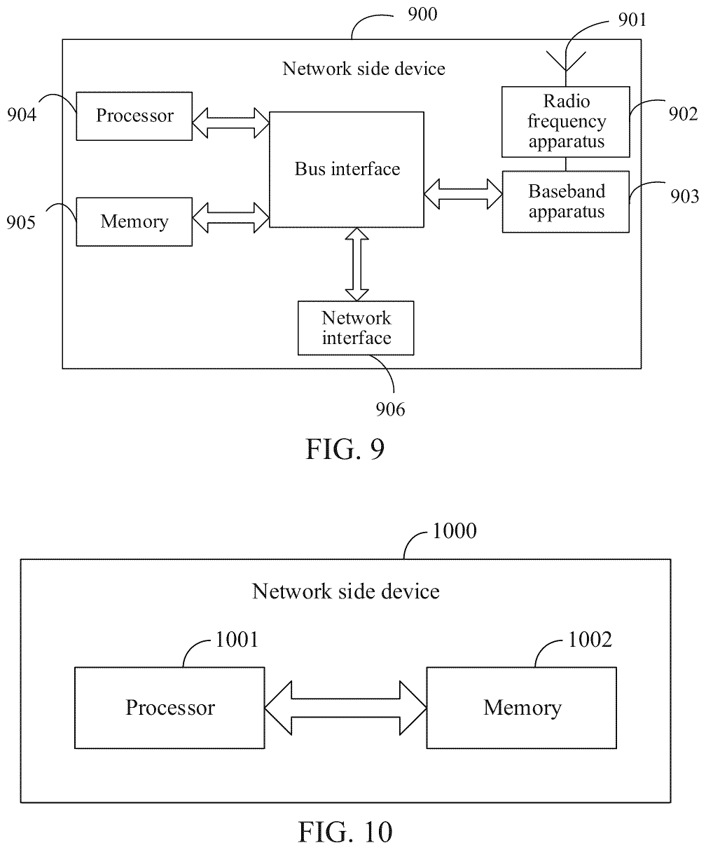

FIG. 9 is a schematic structural diagram 1 of a network side device according to an embodiment of this application. As shown in FIG. 9, a network side device 900 includes: an antenna 901, a radio frequency apparatus 902, and a baseband apparatus 903. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information, and sends the information to the radio frequency apparatus 902, and the radio frequency apparatus 902 processes received information, and then sends the information through the antenna 901.

The information transmission apparatus may be located in the baseband apparatus 903, and the method performed by the network side device in the foregoing embodiments may be implemented in the baseband 903. The baseband apparatus 903 includes a processor 904 and a memory 905.

The baseband 903, for example, may include at least one baseband board. A plurality of chips are arranged on the baseband board. As shown in FIG. 9, one of the chips is, for example, the processor 904, connected to the memory 905, to invoke a program in the memory 905 performing an operation of the network side device shown in the method embodiments.

The baseband apparatus 903 may further include a network interface 906, configured to exchange information with the radio frequency apparatus 902. The interface is, for example, a common public radio interface (CPRI for short).

Specifically, the network side device in the embodiments of the present invention further includes: instructions or a program stored in the memory 905 and executable on the processor 904. The processor 904 invokes the instructions or the program in the memory 905, performing steps of the method embodiments of the network side device, and achieving the same technical effect. To avoid repetition, details are not described herein again.

FIG. 10 is a schematic structural diagram 2 of a network side device according to an embodiment of this application. As shown in FIG. 10, a network side device 1000 includes a processor 1001, a memory 1002, and a program or instructions stored in the memory 1002 and executable on the processor 1001. The program or the instructions, when executed by the processor 1001, implement all processes of the embodiments of the information transmission method, and can achieve the same technical effect. To avoid repetition, details are not described herein again.

The embodiments of this application further provide a readable storage medium. The readable storage medium may be volatile, or may be non-volatile. The readable storage medium stores a program or instructions. The program or the instructions, when executed by a processor, implement all processes of the embodiments of the information transmission method, and can achieve the same technical effect. To avoid repetition, details are not described herein again.

The processor is the processor in the terminal in the foregoing embodiments. The readable storage medium includes a computer-readable storage medium, such as a computer read-only memory (ROM), a random access memory (RAM), a magnetic disk, or an optical disc.

The embodiments of this application further provide a chip. The chip includes a processor and a communication interface. The communication interface is coupled to the processor. The processor is configured to execute a program or instructions to implement all processes of the embodiments of the information transmission method, and can achieve the same technical effect. To avoid repetition, details are not described herein again.

It should be understood that the chip provided in the embodiments of this application may also be referred to as a system level chip, a system chip, a chip system, a system on a chip, or the like.

The embodiments of this application further provide a computer program/program product. The computer program/program product is stored in a non-transitory storage medium. The computer program/program product is executed by at least one processor to implement all processes of the embodiments of the information transmission method, and can achieve the same technical effect. To avoid repetition, details are not described herein again.

It should be noted that terms “include”, “comprise”, or any other variation thereof in this specification is intended to cover a non-exclusive inclusion, which specifies the presence of stated processes, methods, objects, or apparatuses, but do not preclude the presence or addition of one or more other processes, methods, objects, or apparatuses. Without more limitations, elements defined by the sentence “including one” does not exclude that there are still other same elements in the processes, methods, objects, or apparatuses. In addition, it should be noted that the scope of the methods and apparatuses in the embodiments of this application is not limited to performing functions in the order shown or discussed, and may also include performing functions in a substantially simultaneous manner or in reverse order according to the functions involved. For example, the methods described may be performed in an order different from that described, and various steps may be added, omitted, or combined. In addition, features described with reference to some examples may be combined in other examples.

Through the descriptions of the foregoing implementations, a person skilled in the art may clearly understand that the method in the foregoing embodiments may be implemented by using software and a necessary general hardware platform, and certainly, may alternatively be implemented by hardware, but in many cases, the former manner is a better implementation. Based on such an understanding, the technical solutions of this application essentially or the part contributing to the related art may be implemented in a form of a computer software product. The computer software product is stored in a storage medium (such as a ROM/RAM, a magnetic disk, or an optical disc) and includes several instructions for instructing a terminal (which may be a mobile phone, a computer, a server, a network device, or the like) to perform the methods described in the embodiments of this application.

The embodiments of this application are described above with reference to the accompanying drawings. However, this application is not limited to the foregoing specific implementations. The foregoing specific implementations are illustrative instead of limitative. Enlightened by this application, a person of ordinary skill in the art can make many forms without departing from the idea of this application and the scope of protection of the claims. All of the forms fall within the protection of this application.

What is claimed is:

1. An information transmission method, comprising:
receiving, by a terminal, first signaling sent by a network side device, wherein the first signaling comprises at least one of the following:
first indication information, indicating the terminal to switch a transmission waveform; or
waveform information, used for determining information about a target transmission waveform;
wherein the first signaling comprises DCI; and the DCI comprises the first indication information and/or the waveform information;
wherein an additional new domain in the DCI comprises the first indication information and/or the waveform information; or
a target domain in the DCI comprises the first indication information and/or the waveform information.

2. The information transmission method according to claim 1, wherein after the receiving, by a terminal, first signaling sent by a network side device, the method further comprises:
determining, by the terminal, a target resource allocation manner and a size of a frequency domain resource allocation (FDRA) domain in downlink control information (DCI) based on the first signaling.

3. The information transmission method according to claim 2, wherein the determining, by the terminal, a target resource allocation manner and a size of a frequency domain resource allocation (FDRA) domain in downlink control information (DCI) based on the first signaling comprises:
determining, by the terminal in a case that the first signaling is received, that the target resource allocation manner is a first resource allocation manner, wherein the first resource allocation manner is a resource allocation manner in which resources are continuous; and
determining, by the terminal, that the size of the FDRA domain is a first reference value.

4. The information transmission method according to claim 2, wherein the determining, by the terminal, a target resource allocation manner and a size of a frequency domain resource allocation (FDRA) domain in downlink control information (DCI) based on the first signaling comprises:
determining, by the terminal, the target transmission waveform based on the first signaling; and
determining, by the terminal, the target resource allocation manner and the size of the FDRA domain in the DCI based on the target transmission waveform.

5. The information transmission method according to claim 4, wherein the determining, by the terminal, the target resource allocation manner and the size of the FDRA domain in the DCI based on the target transmission waveform comprises:
determining, by the terminal in a case that a resource allocation manner configured by the network side device is a second resource allocation manner, and the target transmission waveform comprises a cyclic prefix orthogonal frequency division multiplexing (CP-OFDM) waveform, that the target resource allocation manner is the second resource allocation manner, and determining that the size of the FDRA domain is a second reference value, wherein the second resource allocation manner is a resource allocation manner in which resources are not continuous; or
determining, by the terminal in a case that a resource allocation manner configured by the network side device is a second resource allocation manner, and the target transmission waveform comprises a discrete Fourier transform-spread orthogonal frequency division multiplexing (DFT-S-OFDM) waveform, that the target resource allocation manner is a first resource allocation manner, and determining that the size of the FDRA domain is a third reference value, wherein the third reference value is greater than the second reference value.

6. The information transmission method according to claim 4, wherein the determining, by the terminal, the target resource allocation manner and the size of the FDRA domain in the DCI based on the target transmission waveform comprises:
determining, by the terminal in a case that a resource allocation manner configured by the network side device is a first resource allocation manner, that the target resource allocation manner is the first resource allocation manner, and determining that the size of the FDRA domain is a first reference value.

7. The information transmission method according to claim 4, wherein the determining, by the terminal, the target resource allocation manner and the size of the FDRA domain in the DCI based on the target transmission waveform comprises:
determining, by the terminal in a case that a resource allocation manner configured by the network side device is dynamic switching, that the size of the FDRA domain is a third reference value; and
determining the target resource allocation manner based on the size of the FDRA domain.

8. The information transmission method according to claim 4, wherein the determining, by the terminal, the target resource allocation manner and the size of the FDRA domain in the DCI based on the target transmission waveform comprises:
determining, by the terminal in a case that the target transmission waveform comprises a DFT-S-OFDM waveform, and a resource allocation manner configured by the network side device is a third resource allocation manner, that the target resource allocation manner is a first resource allocation manner, and determining that the size of the FDRA domain is a fourth reference value, wherein the third resource allocation manner is a resource allocation manner that is based on an unauthorized frequency band.

9. The information transmission method according to claim 2, wherein after the determining, by the terminal, the target resource allocation manner and the size of the FDRA domain in the DCI based on the target transmission waveform, the method further comprises:
transmitting, by the terminal by using a frequency domain resource determined based on the target resource allocation manner and the size of the FDRA domain in the DCI, a signal satisfying the target transmission waveform.

10. The information transmission method according to claim 2, wherein after the determining, by the terminal, the target resource allocation manner and the size of the FDRA domain in the DCI based on the target transmission waveform, the method further comprises:
obtaining, by the terminal based on information about M LSBs or MSBs in the FDRA domain, frequency domain resource allocation information indicated by the FDRA domain, wherein M is a positive integer.

11. The information transmission method according to claim 1, wherein the target domain comprises at least one of the following: an FDRA domain, an antenna port domain, or a transmitted precoding matrix indicator (TPMI) domain.

12. The information transmission method according to claim 11, wherein in a case that the target domain comprises the FDRA domain, the FDRA domain comprises N1 bits and N2 bits, wherein the N1 bits are used to carry the first indication information and/or the waveform information; the N2 bits indicate frequency domain resource configuration information of the target transmission waveform; and N1 and N2 are both positive integers.

13. The information transmission method according to claim 11, wherein in a case that the target domain comprises the antenna port domain, the antenna port domain comprises N3 bits and N4 bits, wherein the N3 bits are used to carry the first indication information and/or the waveform information; the N4 bits indicate antenna port configuration information corresponding to the target transmission waveform; and N3 and N4 are both positive integers.

14. The information transmission method according to claim 11, wherein in a case that the target domain comprises the TPMI domain, the TPMI domain comprises N5 bits, wherein the N5 bits are used to carry the first indication information and/or the waveform information; and N5 is a positive integer greater than or equal to 1.

15. The information transmission method according to claim 11, wherein the TPMI domain comprises layer information of a signal and information about the target transmission waveform corresponding to precoding information.

16. An information transmission method, comprising:
sending, by a network side device, first signaling to a terminal, wherein the first signaling comprises at least one of the following:
first indication information, indicating the terminal to switch a transmission waveform; or
waveform information, used for determining information about a target transmission waveform;
wherein the first signaling comprises DCI; and the DCI comprises the first indication information and/or the waveform information.

17. The information transmission method according to claim 16, wherein a resource allocation manner configured by the network side device for the terminal is a first resource allocation manner; and the first resource allocation manner is a resource allocation manner in which resources are continuous.

18. A terminal, comprising a processor, a memory, and a program or instructions stored in the memory and executable on the processor, wherein the program or the instructions, when executed by the processor, causes the terminal to perform:
receiving first signaling sent by a network side device, wherein the first signaling comprises at least one of the following:
first indication information, indicating the terminal to switch a transmission waveform; or
waveform information, used for determining information about a target transmission waveform;
wherein the first signaling comprises DCI; and the DCI comprises the first indication information and/or the waveform information.

19. A network side device, comprising a processor, a memory, and a program or instructions stored in the memory and executable on the processor, and the program or the instructions, when executed by the processor, implementing steps of the information transmission method according to claim 16.

20. A non-transitory readable storage medium, storing a program or instructions, and the program or the instructions, when executed by a processor, implementing the information transmission method according to claim 1.
